(19) United States
(12) Patent Application Publication
(10) Pub. No.: US 2025/0214283 A1
(43) Pub. Date: Jul. 3, 2025

(54) MANUFACTURING SYSTEM FOR MOULDS FOR CAST COSMETIC PRODUCTS, METHOD AND MOULD

(71) Applicant: RC STAMPI SRL, Crespiatico (CR)

(72) Inventor: Roberto CAMPANINI, Chieve (IT)

(21) Appl. No.: 18/991,697

(22) Filed: Dec. 23, 2024

Related U.S. Application Data
(62) Division of application No. 18/032,344, filed on Apr. 18, 2023.

(51) Int. Cl. B29C 33/38; A45D 40/16; B21D 37/20; B29C 33/42; B29C 39/02

(52) U.S. Cl. CPC B29C 33/3842; A45D 40/16; B21D 37/20; B29C 33/424; B29C 39/026

(57) ABSTRACT

The present invention relates specifically to moulds for cosmetic products, even more specifically to moulds for so-called “stick” products or cast products in general, to which category may belong, for example, lip glosses, lipsticks, foundations, concealers, etc. other products belonging to the same category. In particular, the present invention relates to an innovative system and method for making moulds for cosmetic products such as moulds for lipsticks, for cast products in general, moulds for compacting powders, in practice any mould for cast products in which there is a request for customization in terms of shape, logo, design and workmanship.

### SCOPE OF THE INVENTION

The present invention relates in particular to moulds for cosmetic products, even more particularly to moulds for so-called “stick” products or cast products in general, to which category may belong, for example, lip glosses, lipsticks, foundations, concealers, etc. other products belonging to the same category.

In particular, the present invention relates to an innovative system and method for making moulds for cosmetic products such as moulds for lipsticks, for cast products in general (sticks), moulds for compacting powders, in practice any mould for cast products in which you have a request for customization in terms of shape, logo, design and workmanship.

### STATE OF THE ART

With reference to the state of the art in the sector of moulding of cast products, to date, in particular the applicant, in an innovative way, produced moulds for cosmetic products with a machine called in the CNC machining center sector and the processing was performed with tools (cutters or burins) that performed a programmed machining with dedicated 3d design software and a realization path using tools made with cad cam software typically used to create tool paths.

This type of numerically controlled milling machine, as is known, uses four axes for machining, of which three axes for machining on the X, Y and Z axes and one rotary in addition for continuous machining of pieces with circular development of any shape.

As a rule, the working steps for the realization of a mould for cast products comprise: at least one step for the realization of a mould for cast products by means of a CNC-controlled lathe to make a rough-cut, or rough, rebar. So there is a mould loading phase on the machine, mould alignment with 3D drawing SW; machining with the four-axis milling machine to obtain the desired shape and design; then there is a step of extracting the mould halfway through the machining from the machine and polishing or treatment required on a semi-finished surface manually by means of abrasive paper of various grain and therefore, by means of an operator-dependent procedure.

Optionally there can be a finishing phase to reach various degrees of polishing and finishing using a brush and/or diamond paste (if you have a shiny surface, in the case of making a “MAT” or opaque effect lipstick), a sandblaster is used/shot peening machine based on the type of finish required (again another manual machine), with manual processing.

Finally, there is a phase of reloading the mould on the machine for the processing of decorations as desired, such as logo, design only with milling/burin processing, or engravings.

In the final phase, the mould is re-discharged from the machine for possible polishing or surface finishing on manual request, always similar to the previous phase.

Note that the feasible processes are the creation of logos, writings, simple decorations and engravings.

Basically, the final result obtained is a mould product with three-dimensional effects of various shapes and finishes.

As anticipated, the processing can be performed on moulds for lipsticks, cast sticks of various products, moulds for compacting powders, and all moulds with a request for customization in the cosmetic field, even if usually in art this processing was limited to lipstick moulds (unlike an scope of the present invention).

This processing system for moulds for the production of cosmetics, however, although it is at the forefront, as it allows customization of the same, has some significant disadvantages and limitations: for example, the processing is carried out with small tools for which it is not possible obtain excellent quality results given the difficulty of management in terms of precision, and again, disadvantageously, the processes take a very long time both for the type of tools used and for the nature of the processes themselves.

It should be noted, disadvantageously, that there is a wide range of operations, of which for example various among those described above, which disadvantageously are entirely operator-dependent: therefore requiring time, highly specialized personnel and consequently expensive and are definitely affected by the operator's hand. These processes, in fact, are very long and delicate: polishing changes significantly from operator to operator as is known to every expert in the sector, which makes the products not completely repeatable, or very little repeatable, this in a completely disadvantageous way.

Both the imperfect precision in machining and the long time create significant economic disadvantages, since, for an excellent machining it would be tolerable to have longer machining times, compensating with a higher-end quality/price ratio: this does not happen, however, not obtaining an excellent workmanship despite the times.

On the other hand, for a product with a non-optimal or not always precise final finish (i.e. as in this case), at least quick working times would be required to justify a not excellent result and bring it to offer at a more advantageous price.

It is clear that this combination of disadvantages is completely counterproductive for the sector despite the novelty of the processes.

A scope of the present invention is to solve the aforementioned problems of the known art.

A further scope of the present invention is to describe a system and process for the production of moulds for cosmetic products which guarantees the optimal quality of the final product.

Another scope of the present invention is to describe a working system and process which significantly improves the quality of the final product obtained by means of the mould optimized by the innovative working which will be described.

Another scope of the present invention is to obtain a final processing of the product with the most precise and perfect possible finishes.

Another scope of the present invention is to make it possible to produce cosmetic moulds in adequate times to obtain an optimized quality/price ratio on the final product.

Still a further scope of the present invention is to obtain a processing which is completely independent of the ability of the operator, therefore it is perfectly reproducible industrially.

### BRIEF DESCRIPTION OF THE INVENTION

These and further advantages will be obtained thanks to the innovative process and method for the production of moulds for cosmetic products in which a seven-axis controlled CNC machine tool is used here for the production of these moulds.

The seven-axis milling machine is the most versatile and advanced in the class of compact NC machines for all engraving, diamond cutting, drilling and pre-embedding operations on objects of different materials and thicknesses such as balls, rings and bracelets, even empty, round, oval and irregular in shape, both rounded and flat.

Compared to a five-axis milling machine, the seven-axis milling machine guarantees a much finer final texturing quality of the product and much more complex processes that are currently known only in goldsmith's and related fields.

In particular, the five dedicated axes defined: x, y, z, A rotation of the tool axis spindle that supports the workpiece, B rotation around the machine axis, are used to optimize the position of the tool with respect to the workpiece. (The workpiece in one variant is mounted on A and B, XYZ work with the rotating spindle and cutter.)

The other two axes C, U control the tool used at that moment, are integral with the spindle head and perform other machining.

In another variant the piece to be machined is mounted integral with the machine and a tool is integral with the axes AB on which it works.

(The seven-axis milling machines will not be explained here as they are known in themselves to the technique, albeit very innovative, it is emphasized that never before had they been applied to the cosmetics sector.) In fact, it is not enough to think of using this machine for another sector, but it is necessary to create an ad hoc, new and innovative procedure or method, which involves the use of tools specific to the cosmetic sector that have never before been used in the ways that will be described, obviously in addition to the realization of SW programs dedicated to these types of projects that imply an in-depth knowledge of engineering in the cosmetic field and its equipment.

An example of a seven-axis milling machine that is not suitable for the world of cosmetics is well described in the prior art document US 2017 426728 which describes a seven-axis machine of the known art and in particular describes a machine and relative tool for processing on pieces mainly made of glass or the like, in particular said machine is an improvement in lapping. The invention in particular aims at carrying out a polishing process in the shortest possible time and with the least possible removal of material on pieces of glass. To achieve this purpose, a particular tool is used which, in one part, is semi-elastic in order to be able to adapt better even on non-flat surfaces. It is therefore evident that said machine cannot be compatible with the realization of embossed workings on metal surfaces since the tool itself is designed for a leveling and polishing operation and not for the creation of carved details being therefore a classic example of use of a milling machine 7-axis in known art.

The substantial advantage of this 7-axis milling machine applied in the cosmetic sector is that the seven axes allow an inclination of a cutter even with a minimum diameter such that the removal of material on the surface to be machined is much more precise and accurate, optimizing the finishing result. The cutting position is therefore optimized and defined unambiguously and precisely. Returning to the previous discussion, there are two workpiece/tool holder axes AB, two tool holder axes CV and three movement axes of the XYZ machine combined in total seven axes.

On the C and V axes, which the inventor in this case defines and uses as tool holder axes, tools in monocrystalline diamond, or other, can be mounted, for example, while the A, B axes are suitable for handling tools such as a hammer or other equipment.

In a completely innovative way, the advantages described above and the aforementioned problems will be solved thanks to the system described here for the production of moulds for cosmetic products comprising at least the use of a numerically controlled milling machine with at least seven axes (A, B, X, Y, Z, C, V) of which at least the axes (A, B, X, Y, Z) are used for the realization of a mould, for which at least one raw or semi-finished piece is included or a raw mould or semi-finished product for cast cosmetic products (1), at least milling machines and/or other tools for machining moulds characterized by the fact that at least one working tool is a diamond or monocrystalline diamond tip, and/or at least one working tool is a tool “Hammer” to obtain a hammer tip effect, and/or at least one work tool is a “Hydro” tool, and/or at least one work tool is a “zetina” tool, and/or at least one tool for processing the piece includes a single crystal diamond insert suitably shaped to work in removal, compression and polishing and said tools can be used in any combination with each other, said system being suitable for making any mould for cosmetic products cast with high precision of surface finish.

Said system allows the production of moulds for cast products with mould finishes made entirely industrially without the intervention of dedicated personnel, said system being suitable for the production of any mould for cast products.

Note that the 7-axis milling machine is the most innovative to date, said system and method would in any case also be suitable for milling machines with greater precision/machining width, therefore even with more axes.

In a preferred embodiment, the present innovative system and method comprises at least the use of a numerically controlled seven-axis milling machine, at least one blank or a row mould for cast cosmetic products, at least millings and/or other tools for the machining of moulds, in which said system comprises at least the work steps of:
Phase 1: processing of a mould for cosmetic products (for example lipstick, but also for any other mould for other cast products in the cosmetic field) with a lathe in the case of a round mould, or processing of a non-round mould with a CNC milling machine;
Phase 2: loading of the semi-finished product (semi-finished product) such as a pre-worked pre-polished semi-finished lipstick mould on the machine, it is mounted on the workpiece holder of axes A, B;

Remark: in a different embodiment it is also possible to produce the rebar by means of the seven-axis milling machine, but it is a standard processing which for convenience is normally carried out earlier.
Phase 3: centering with feeler to give precise position to the machine (alignment of the piece with the working SW);
Phase 4: creation of a tool path, which corresponds to a customized machining of the mould that is loaded into the machine;
Phase 5: the machine activates the processing in this case the loaded piece being a mould for cast products;
Phase 6: pre-finished machining with milling/burin that work on up to 5 axes for the realization of surface finishes in a more accurate and performing way;
Phase 7.1: disassembly of the piece from the machine for polishing or sandblasting; said method or process is characterized in that it can replace step 7.1 at least with.
Phase 7.2: the blank remains mounted on the machine and by means of the C, V or A, B axes on which a working tool is mounted, in combination with the movement of the other axes it is possible to create either the surface polishing or special effects created by exporting material from the mould.

Particularly advantageously, one of these instruments can be a monocrystalline diamond instrument.

In particular, the diamond removes material creating a “blow” incision, then it also removes and polishes.

In this regard, it should be noted that with traditional milling machines the removals are never a “brilliant” finish while with the monocrystalline diamond tool it is possible to remove the material from the raw mould and perform lapping of the raw material of the mould to obtain an advantageously smooth brilliant finish with a shiny surface: the diamond removes and compresses the material through this action to obtain a perfectly polished surface with sharp edges.

Before the present invention it was never possible in cosmetics to obtain such an effect which is achievable thanks to the use of the monocrystalline diamond instrument.

It should be noted with reference to the known art in terms of processing that on a traditional machine it is impossible to load a diamond tool, this tool is a micromachining tool, traditional machines do not have such accurate control as to manage such tools.

It should be noted that: even thinking of loading a diamond tool on an “old” generation machine, a diamond processing would have been very limited and not at all useful, lacking the necessary fineness of processing possible for the synergistic effect with the seven-axis milling machine.

Note that the use of a monocrystalline diamond tool is completely innovative and never before seen:
in particular in phase 7.2.1 the monocrystalline diamond tool is mounted on a tool holder “fan” spindle made integral with the C axes of horizontal rotation with respect to the spindle axis, and the V rotation axis that rotates on itself, both rotating controlled, these axes in turn move on the XYZ axes. During machining, the V axis rotates with a programmed number of revolutions and acts as a tool holder, combined with the “C” axis it removes material with the shaped diamond, the mould is instead controlled by the A and B axes.

The instrument removes material from the mould and laps the material to have a smooth brilliant finish with a shiny surface, the diamond tool removes and compresses the material.
The C axis can be positioned with respect to the mould to be machined with an inclination angle from 0 to 360 degrees.
In a variant (7.2.1.a): 1st case effect) single stroke, or tracing following a path with a recess in the shape of the tool shape (which is pre-selected before machining and can be of any shape, i.e. the diamond can have any feasible shape suitable for the purpose, the shape of the diamond will give the shape of the final effect, based on the geometry of the diamond).
or the C axis can be rotated (7.2.1.B): in this way there is a controlled rotation to create effects with continuous hits (drift effect).

This allows the creation of completely innovative effects in the cosmetic field: for example, the creation of “step pyramid” effects obtained here by means of arctic diamonds would have had to be created by milling and polishing by hand, a long, complex and expensive operation, and certainly not of quality. In an innovative way, however, it is now possible to create a step pyramid effect in the machine using a monocrystalline tool, which in a programmed way carries out both the processing and the final polishing quickly, precisely and of excellent quality, always thanks to the machining on seven axes. and the instrument mounted on the C, V axes.

It should also be noted, in an entirely advantageous way, that these processes are now completely repeatable, without operator dependent, fast and extremely precise as well as of excellent final quality.

Basically, for seven-axis machining where the diamond cutting tool is used—or other tool suitable for this type of work mounted on CV axes-all seven axes are active, with the tool integral with C, V which can move on XYZ and the workpiece integral to A and B.

It should be noted that the use of a diamond cutting tool is in itself innovative and never seen in the industry.

Alternatively, another innovative process, or another embodiment of the process for making moulds for cast cosmetic products is:

Step 7.2.2 the blank or row mould remains mounted in the machine on a piece holder spindle fixed on A and B, the tool here the tool defined here “Hydro”, is mounted through a tool holder, on a rotary spindle integral with the XYZ axes of the machine.

Said tool then moves with the XYZ axes and rotates, through the rotation of the spindle, at a predefined number of revolutions. This tool can have “different” profiles that can create “different” effects on the mould to be machined, such as for example hemispheres with truncated cone etc. of “different” diameters.

With a correct programming of the machine synergistically with the processing with the Hydro tool, unique effects are created that can simulate “pearls” brilliant “set” diamonds, or finishes such as glossy hemispheres in the mould that create a “necklace effect”, impossible to obtain by hand or with another machine in a precise and controlled way.

Alternatively, other possible processing, or preferred embodiment, comprises:

Step 7.2.3 the blank, or mould, remains mounted in the machine on the machine on the piece holder spindle fixed on A and B, the “Hammer” tool is mounted on the front part of a tool holder spindle integral with the X, Y, Z axes and moves with these axes; when it moves or is activated it becomes a “PNEUMATIC HAMMER” with a diamond at the tip that pulsates and creates a diamond/hammered effect on the workpiece.

Therefore for HAMMER it is defined as: a cylinder-type tool, where a brazed diamond is fixed at the end and when activated a pneumatic vibration is created, therefore the hammer approached the piece creates a hammered effect (note that it is one tool used in jewelry). One has the affection of a hammer beating on an awl that carves a piece.

It is possible to create a hammered effect on the surface of the piece/mould with various degrees of hammering.

(In particular, the tip of the pneumatic hammer moves in a controlled way on the five axes, in a completely advantageous and innovative way—not even in jewelry there is such a degree of finish.)

Still, a further embodiment is:

Step 7.2.4 the blank remains mounted in the machine and always on A and B, the tool is a “zetina” and is mounted on the front part of a tool holder spindle integral with the X, Y, Z axes and moves with these axes and it can rotate by a predetermined number of revolutions. The tool is a cylinder in the shape of a “cob” or comb with fixed cutting edges, in miniature, and works with the side facing the piece, passing over the piece the zetina “scratches” it but the effect is so fine that it looks like a satin finish with an opaque effect, the material is treated uniformly, and it is worked by removing the material. (unlike what happens with a wire brush that serves to scratch the material without removing it)

The section of a comb with alternating fine teeth to create a satin and brushed effect.

This effect resembles the satin finishing performed with manual abrasive brushes, that is the opacification obtained by brushes with various degrees of abrasive, as already mentioned the manual skill of this operation made it slow, dependent and imprecise operator, for which advantageously the present invention improves also this aspect.

Here the tool works in rotation by combining the movement of the five axes with an inclination angle perpendicular to the surface of the mould, and rotates with a number of spindle revolutions and part rotation suitable to create a satin effect.

In further embodiments, it should be borne in mind that the shape of the aforementioned tools can obviously vary allowing to obtain different finishing effects, such as for example a sequin effect (e.g. Hydro with a flat tip) shiny circles with a programmable pitch and an adjustable inclination (this using the 5 axes) obtaining, as mentioned, a sequin-like effect.

In particular, the Hydro tool is a cylinder comprising a brazed diamond shaped in any desired shape, the Hydro tool works by removal like a milling machine or a bit like a drill.

The innovation in particular obtained thanks to these tools is united by processing with monocrystalline diamond which they are all equipped with and in particular defined as “brazed” (for how the diamond is fixed to the tool) and in particular it works in removal, compression and polishing this being automated and completely innovative in the cosmetics sector.

Another example of a possible embodiment: using a “pointed” diamond on the diamond cutting tool a path is programmed and the point creates a shiny trace. NOTE: With manual polishing I can't get sharp edges or zero radius, while with diamond yes.

Obviously, the type of tool to be used in step 7.2.n can also change and with it the shapes of the diamond cutting tools, zetina, hammer, Hydro or other tool suitable for machining on moulds for cast cosmetic products processed with a 7-axis milling machine.

The advantages are in particular the precision of the finish and the optimized quality in addition to the innovative effects shown below, never achieved before in the cosmetics sector.

### BRIEF DESCRIPTION OF THE INVENTION

These and further advantages obtained thanks to the innovative manufacturing system for moulds for cast cosmetic products which includes a related innovative process will be better clarified in the description of some embodiments of moulds obtained innovatively thanks to the present invention, in which these figures have the purpose merely representative and not limitative of the present invention in which:

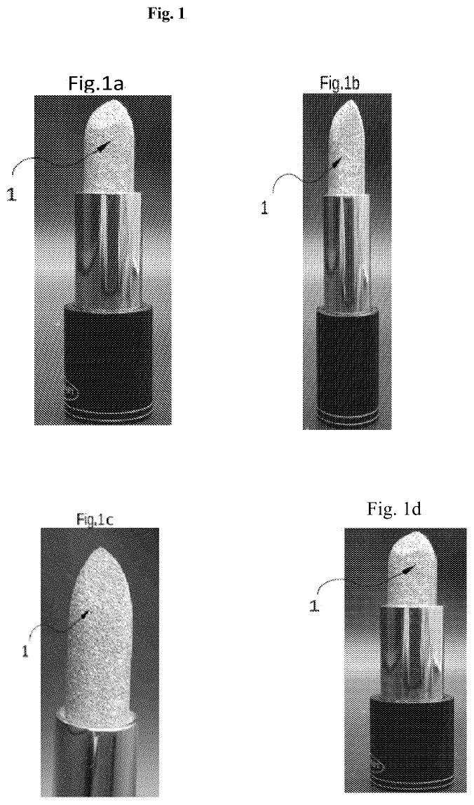

in FIG. 1a, b, c, d is shown in various views a particularly preferred embodiment of the present invention in which the worked piece, i.e. the mould, in this case for lipsticks, has a “Hammer” finish.

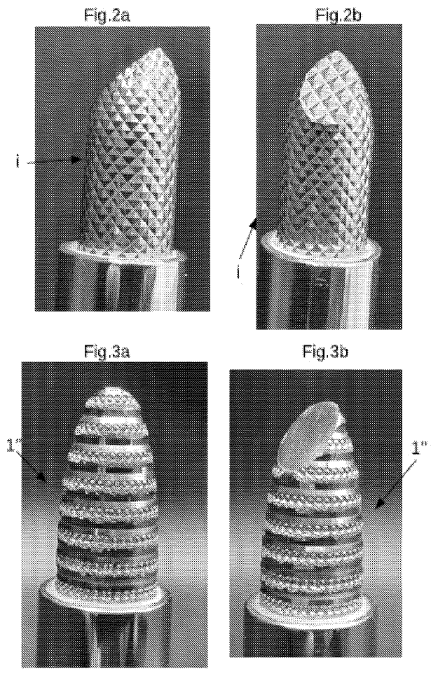

in FIG. 2a, b shows in various views a particularly preferred embodiment of the present invention in which the worked piece, i.e. the mould, in this case for lipsticks, has a diamond machining finish.

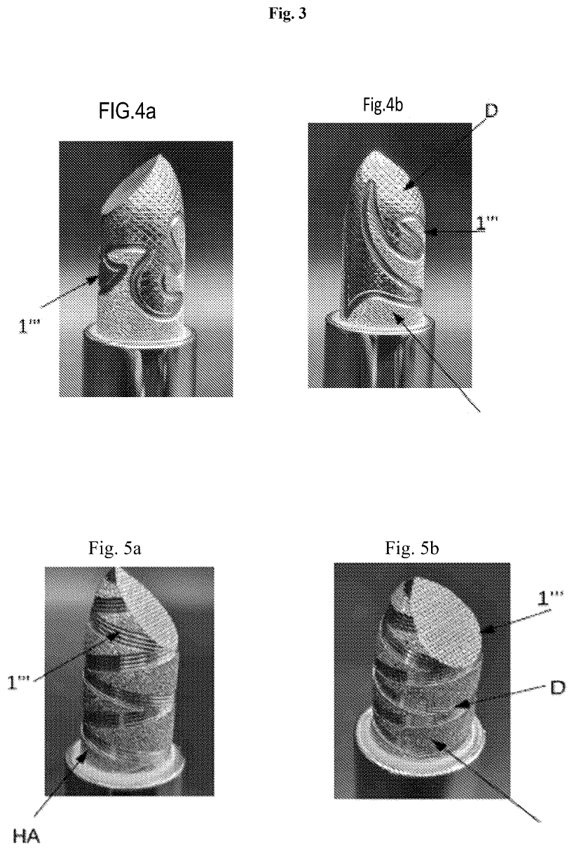

in FIG. 3a, b shows in various views a particularly preferred embodiment of the present invention in which the worked piece, i.e. the mould, in this case for lipsticks, has a mixed working finish;

in FIG. 4a, 4b shows in various views a particularly preferred embodiment of the present invention in which the worked piece, i.e. the mould, in this case for lipsticks, has a mixed working finish;

and finally in FIG. 5a, 5b shows in various views a particularly preferred embodiment of the present invention in which the worked piece, i.e. the mould, in this case for lipsticks, has a mixed working finish.

### DESCRIPTION OF THE DRAWINGS

The innovative manufacturing system for moulds for cast cosmetic products has been exhaustively described above, the figures shown here are real examples of absolutely innovative processes from the point of view of quality, finishing precision, industrial repeatability of processing (being independent from the operator) obtained thanks to this system and method.

In particular, FIG. 1a, b, c, d shows a first realization of the finished piece 1, i.e. in this case a mould for lipsticks, i.e. a lipstick male as called in the sector, obtained thanks to the present invention, in this particular case it is obtained with the system and method described above as in points from 1 to 7.2.3 i.e. the tool used for the machining and to obtain this “hammered” effect is precisely the Hammer tool that works as in point 7.2.3.

Then with reference in particular to FIGS. 2a, b there is shown a further embodiment, again in this case of a mould for lipsticks 1′ made according to the system and method described in steps 1 to 7.2.1.a.

The final effect obtained advantageously has sharp edges of perfect formation and superior polishing.

With reference now to FIGS. 3a, b there is shown a further particularly preferred innovative embodiment of a finished product mould for cast products, in this case a male for lipsticks 1″ obtained in this case from phases 1 to 6 and 7.2.1 i.e. diamond tool processing and 7.2.2 i.e. processing with a Hydro tool in which the “necklace” effect is obtained thanks to the Hydro processing and the double shiny effect thanks to the processing with a diamond tool. Also in this case, in a particularly advantageous way, this effect and degree of finish is absolutely innovative and allows the creation of the subsequent cast product, that is the finished lipstick with excellent quality yield.

It should be noted that it is indifferent to do one or the other processing first.

Still with reference to FIGS. 4a, b there is shown a further particularly preferred innovative embodiment of a finished product mould for cast products, in this case a male for lipsticks 1′″ in which in a particularly innovative way, in addition to the steps to be 1 to 6 said mould is obtained thanks to the combinations of phase 7.2.1.a i.e. machining the diamond tool on the side marked D, with phase 7.2.3 i.e. machining with the Hammer tool on the side marked with HA and milling on the fret side of the division between the HA and D side.

Finally, FIGS. 5a, b show a further example of a particularly preferred embodiment of mould 1″″, in this case for lipsticks, again obtained from the processing steps 1 to 6 and in this case then in combination with phases 7.2.3 i.e. by means of the Hammer tool for the hammered part HA and by phase 7.2.1.a i.e. by means of a diamond tool for part D or by the polished bands that surround the mould 1″″.

Therefore the phases 7.2.1-7.2n, (in which “n” is a phase including any tool or the same tool with modified shape) can be combined with each other in combinations of two or more machining operations on the same raw or semi-finished piece, i.e. mould for lipsticks, to obtain moulds for cast products with processes mixed together in any way, the processes can take place in any order. It is therefore evident that the machining combinations obtained thanks to the different tools used, including diamond cutting tool, hammer, Hydro and Zetina are just some examples of tools that are innovatively used and made specifically for the production of moulds for cosmetic products as well as by the system and method described by the present invention, so that other tools, provided they are used with a 7-axis milling machine as described by the present invention, are included in the scope of the present description as possible alternative embodiments.

It should also be noted that the diamond cutting tool is used through the synergistic action of the seven axes of the milling machine.

The tools Hammer, Hydro, zetina and others possible depending on the finish of the chosen mould embodiment can instead be loaded on a tool holder spindle at the same time (integral with the AB axes), and the spindle, rotating, depending on the machine settings will put the chosen tool into action. Or it will be possible to load and unload the tool from the machine as needed. Furthermore, it is evident that the embodiments described herein are merely examples, in fact this system and method is suitable for the production of any cosmetic mould for cast products.

Furthermore, the processing combinations can be any according to the manufacturing requirements.

It therefore appears evident that the innovative system and method for making moulds for cosmetics for cast products described by the present invention allows to achieve all the purposes described above.

It is equally evident that the mould male for cast cosmetic products thus obtained is equally innovative due to the nature of its realization as extensively described and combinations of methods referred to in the previous processes in which this mould is a male for the realization of any cosmetic product provided that it is cast, comprising from one to any number of machining operations by means of a seven-axis milling machine with finishing carried out by means of a diamond cutting tool, zetina, hammer, Hydro or other tool or combination of machining of such tools with any variation of external shape.

As already said, at least one or more of said tools are characterized by the fact that they comprise at least one monocrystalline diamond on the tool for machining the rough or semi-finished piece.

It is even more evident that the moulds for innovative high performance cast cosmetic products obtained thanks to the present invention are themselves innovative by their functional performance nature and for the optimization of obtaining a high quality cast cosmetic product, excellent finish, obtained quickly, non-operator dependent and with a good economic relationship as well as a very high degree of originality.

Further variants in materials used for any part of the mould, tools used, shape, size of the same, materials of moulds, i.e. pieces to be machined and tools, combinations of processes, provided that the system and method described by the present invention are maintained, as well as the products endings obtained, that is moulds for innovative high performance cast cosmetic product, are to be considered scope of the present invention as better defined by the attached claims.

We claim:

1. A process or method for the realization of moulds for cast cosmetic products as per the system according to the preceding claims, comprising at least the steps of:
Phase 1: processing of a mould for cosmetic products with a lathe in the case of a round mould, or processing of a non-round mould with a CNC milling machine, or with a seven-axis milling machine;
Phase 2: loading of the semi-finished product (semi-finished product) such as a mould for pre-processed, pre-polished semi-finished cosmetic product on the seven-axis milling machine, the mould is mounted on a piece-holding spindle of the axes (A, B);
Phase 3: centering with feeler to give precise position to the seven-axis machine with respect to the raw mould;
Phase 4: creation of a tool path, which corresponds to a customized machining of the mould that is loaded into the machine;
Phase 5: activates machining in a seven-axis machine, in this case the loaded piece being a mould for cast products;
Phase 6: realization of pre-finished mould in processing with milling/burin that work on up to five axes for the realization of surface finishes, in a more accurate and fully automated way;
Phase 7.1: disassembly of the piece from the machine for polishing or sandblasting;
characterized by the fact that step 7.1. can be replaced by the phase:
Phase 7.2: the blank remains mounted on the machine and by means of the axes (C, V) or (A, B) on which a working tool is mounted, in combination with the movement of the other axes (X, Y, Z) or (X, Y, Z, A, B) either the polishing of the surface of the mould or of the special effects made by exporting material from the mould is carried out.

2. The process or method for the realization of moulds for cast cosmetic products as per the system according to the claim 1, in which step 7.2 in particular is a step 7.2.1, in which:
Phase 7.2.1 the monocrystalline diamond tool is mounted on a tool holder “fan” spindle made integral with the C axes of horizontal rotation with respect to the spindle axis, and the V rotation axis that rotates on itself, both in controlled rotation, these axes in turn move on the XYZ axes, during machining the V axis rotates with a programmed number of revolutions and acts as a tool holder, combined with the “C” axis removes material with the shaped diamond, the mould is instead controlled by the A and B axes;
the C axis can be positioned with respect to the mould to be machined with an angle of 0-360 degrees;
variant (7.2.1.a): 1st case effect) single stroke or tracing following a path with a recess in the shape of the tool shape (which is pre-selected before machining and can be of any shape, i.e. the diamond can have any feasible shape suitable for the purpose, the shape of the diamond will give the shape of the final effect, based on the geometry of the diamond).
Or phase (7.2.1.B) the C axis can be made to rotate, in this way there is a controlled rotation to create effects with continuous strokes or a “drift” effect.

3. The process or method for the realization of moulds for cast cosmetic products as per the system according to the claim 1, in which phase 7.2 in particular is phase 7.2.2.:
in which
Phase 7.2.2.: the blank or blank mould remains mounted in the machine on a piece holder spindle fixed on (A and B), the tool here, the tool defined here “Hydro”, is mounted through a tool holder, on a rotary spindle integral with the axes (XYZ) of the machine.
said tool then moves with the XYZ axes and rotates, through the rotation of the spindle, at a predefined number of revolutions: this tool can have “different” profiles that can create “different” effects on the mould to be machined, such as hemispheres with truncated cone etc. of “different” diameters.
programming the machine synergistically with the processing with the Hydro tool to create effects that can simulate “pearls” brilliant diamonds “set”, or finishes such as glossy hemispheres in the mould that create a “necklace effect”, impossible to obtain by hand or with another machine in precise and controlled way.

4. The process or method for the realization of moulds for cast cosmetic products as per the system according to the claim 1, in which phase 7.2 in particular is a phase 7.2.3
in which
Phase 7.2.3. the blank, or mould, remains mounted in the machine on the piece holder spindle fixed on (A and B), the “Hammer” tool is mounted on the front part of a tool holder spindle integral with the axes (X, Y, Z) and moves with these axes; when it moves or is activated it becomes a “pneumatic hammer” with a diamond at the tip that pulses and creates a diamond/hammered effect on the workpiece, the tip of the pneumatic hammer moves in a controlled manner on the five axes;
It is possible to create a hammered effect on the surface of the piece/mould with various degrees of hammering.

5. The process or method for the realization of moulds for cast cosmetic products as per the system according to the claim 1, in which phase 7.2 in particular is a phase 7.2.4.
in which
Phase 7.2.4. the blank remains mounted in the machine and always on board the axes (A and B), the tool is a “zetina” tool and is mounted on the front part of a tool holder spindle integral with the axes (X, Y, Z) and it moves with these axes and can rotate by a predetermined number of revolutions; the zetina tool works with the side facing the raw moulded piece and this side has the section of a comb with alternating fine teeth to create a satin and brushed effect;
the tool works here in rotation by combining the movement of the five axes with an inclination angle perpendicular to the surface of the mould, and rotates with a number of spindle revolutions and piece rotation suitable to create a satin effect.

6. A System, process or method for the realization of moulds for cast cosmetic products as per the system according to the claim 1, in which phase 7.2 in particular is a phase 7.2.n herein it can also change the type of tool to be used in step 7.2.n and with it the shapes of the diamond cutting tools, zetina, hammer, Hydro or other tool suitable for working on moulds for cast cosmetic products processed with a 7-axis milling machine, for example.

7. The Process or method for the realization of moulds for cast cosmetic products as per the system according to the claim 1, in which the phases (7.2.1-7.2n) can be combined with each other in combinations of two or more processes on the same raw or semi-finished piece, to obtain moulds for cast products with processes mixed together in any way, and in any processing order.

8. A mould device for cast cosmetic products made as per the system referred to in the previous claims and combinations of methods referred to in the previous processes in which this mould is a male for the production of any cosmetic product as long as it is cast, comprising from one to any number of processes by means of a milling machine with at least seven axes with a finish made by means of a diamond drill, zetina, hammer, Hydro or other tool or combination of machining such tools, at least one comprising a monocrystalline diamond with any variation of external shape.
